(19) United States
(12) Patent Application Publication
(10) Pub. No.: US 2014/0251861 A1
(43) Pub. Date: Sep. 11, 2014

(54) PILL CONTAINER WITH REGISTER AND PUSH BUTTON LIDS AND METHODS

(71) Applicant: APOTHECARY PRODUCTS, INC., Burnsville, MN (US)

(72) Inventors: Robert N. Priebe, Bloomington, MN (US); Terrance O. Noble, Burnsville, MN (US)

(73) Assignee: Apothecary Products, Inc., Burnsville, MN (US)

(21) Appl. No.: 13/789,929

(22) Filed: Mar. 8, 2013

(51) Int. Cl. A61J 1/03; B65B 5/10

(52) U.S. Cl. CPC A61J 1/03; B65B 5/10
USPC 206/534; 206/538; 53/467

(57) ABSTRACT

A multiple compartment container includes a self-contained register unit removably attached to the bottom wall of the base of the container. A method of using the container includes removably attaching the self-contained register unit to the bottom wall of the base of the container.

### TECHNICAL FIELD

This disclosure relates generally to storage containers. In particular, this disclosure relates to a storage container for pills including a removable register for holding information, such as medicine information.

### BACKGROUND

For persons who need to take medicine regularly, the need for a pill container than can be easily carried is important. A pill container that is easy to use, has sufficient capacity for the person's needs, and which can be conveniently carried by the user increases the likelihood that the user will take the correct medication at the correct time.

Some pill containers are difficult for the user to manipulate, especially if the user has arthritic hands, poor eyesight, poor dexterity, or weak muscles. Some medication schedules are complicated, and the user needs a schedule to consult.

Improvements in the usability of pill containers are desirable.

### SUMMARY

A multiple compartment container is provided. The container includes a base having at least first and second rows of compartments, with each compartment having an access opening providing access to an interior volume. The base has a base front wall, a base rear wall opposite of the base front wall, a first side wall extending between the base front wall and base rear wall, a second side wall extending between the base front wall and rear wall, and a base bottom wall opposite of the access opening. Each compartment row has a front row wall and a rear row wall. There are a plurality of lids. Each lid has an attached end that is movably attached to the rear row wall and a free end that is movable to and away from the front row wall such that the lid selectively covers and uncovers the access opening of a respective compartment. A self-contained register unit is removably attached to the bottom wall of the base.

In another aspect, a method of using a multiple compartment container is provided. The method includes providing a container including a base having at least first and second rows of compartments, with each compartment having an access opening providing access to an interior volume. The base has a base front wall, a base rear wall opposite of the base front wall, a first side wall extending between the base front wall and base rear wall, a second side wall extending between the base front wall and rear wall, and a base bottom wall opposite of the access opening. Each compartment row has a front row wall and a rear row wall. A plurality of lids is provided. Each lid has an attached end that is movably attached to the rear row wall and a free end movable to and away from the front row wall such that the lid selectively covers and uncovers the access opening of a respective compartment. A self-contained register unit is part of the container. The method includes removably attaching the self-contained register unit to the bottom wall of the base.

A variety of examples of desirable product features or methods are set forth in the description that follows, and in part will be apparent from the description, or may be learned by practicing various aspects of the disclosure. The aspects of the disclosure may relate to individual features, as well as combinations of features. It is to be understood that both the foregoing general description and the following detailed description are explanatory only, and are not restrictive of the claimed invention.

### BRIEF DESCRIPTION OF THE DRAWINGS

FIG. 1 is a perspective view of a first embodiment of a multiple compartment container constructed in accordance with principles of this disclosure;

FIG. 2 is a front view of the container of FIG. 1;

FIG. 3 is a rear view of the container of FIG. 1;

FIG. 4 is a right view of the container of FIG. 1;

FIG. 5 is a left view of the container of FIG. 1;

FIG. 6 is a top view of the container of FIG. 1;

FIG. 7 is a cross-sectional view of the container of FIG. 1, the cross-section being taken along the line A-A of FIG. 6;

FIG. 8 is a cross-sectional view of the container of FIG. 1, the cross-section being taken along the line B-B of FIG. 6:

FIG. 9 is a bottom view of the container of FIG. 1, but with a cover over the register unit being omitted for purposes of enhancing visibility;

FIG. 10 is a top, exploded perspective view of the container of FIG. 1;

FIG. 11 is a bottom, exploded perspective view of the container of FIG. 1;

FIG. 12 is a bottom view of the container of FIG. 1 with the register unit removed from a remaining portion of the container;

FIG. 13 is a cross-sectional view of the container of FIG. 12, the cross-section being taken along the line C-C of FIG. 12;

FIG. 14 is an enlarged view of a portion of the cross-section depicted in FIG. 13;

FIG. 15 is a perspective view of the flexible pill holders that can be used with the self-contained register unit of FIG. 16;

FIG. 16 is a perspective view of a self-contained register unit removed from the container of FIG. 1;

FIG. 17 is a plan view of the register unit of FIG. 16;

FIG. 18 is a plan view of the register unit of FIG. 16 and from an opposite side as the view of FIG. 17;

FIG. 19 is a cross-sectional view of the register unit of FIG. 16, the cross-section being taken along the line D-D of FIG. 17;

FIG. 20 is a top view of a cover used with the self-contained register unit of FIG. 16, the cover being omitted in FIG. 16;

FIG. 21 is a side view of the cover of FIG. 20;

FIG. 22 is an enlarged view of a portion of the cover shown in FIG. 21;

FIG. 23 is a perspective view of the tab used with the container of FIG. 1;

FIG. 24 is a bottom view of the tab of FIG. 23;

FIG. 25 is a top view of the tab of FIG. 23;

FIG. 26 is a left side view of the tab of FIG. 23;

FIG. 27 is a bottom view of a row of lids used with the container of FIG. 1;

FIG. 28 is a cross-sectional view of one of the lids of FIG. 27, the cross-section being taken along the line E-E of FIG. 27;

FIG. 29 is a top view of the container of FIG. 1, and showing two of the lids in an open condition;

FIG. 30 is a front view of the container of FIG. 29, two of the lids being shown in an open condition; and

FIG. 31 is a right view of the container of FIG. 29, in which one of the lids can be seen in an open condition.

### DETAILED DESCRIPTION

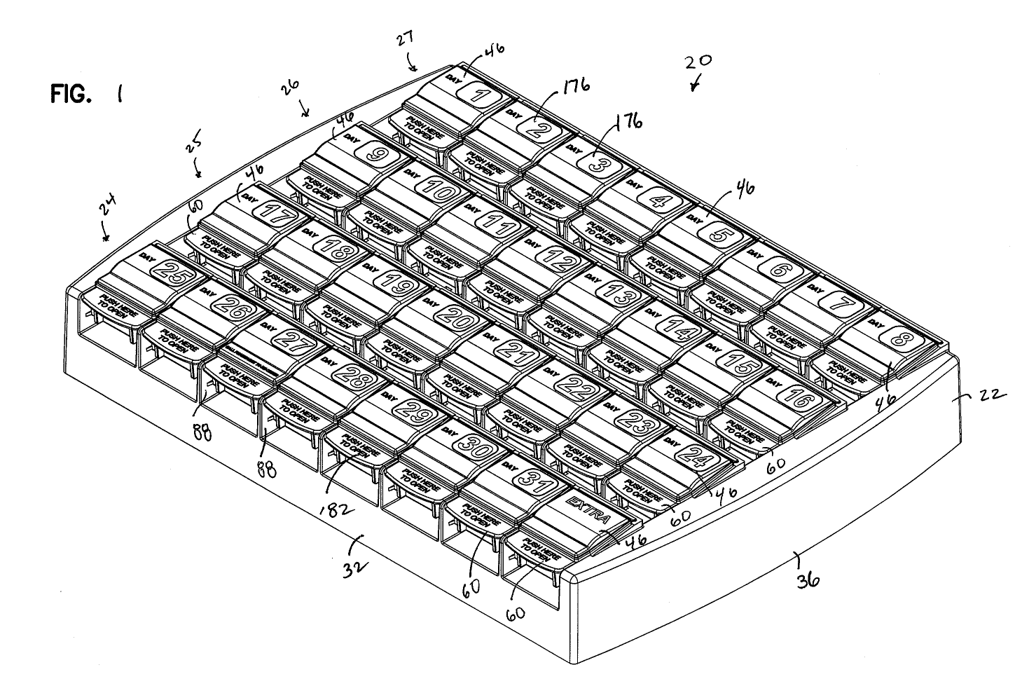

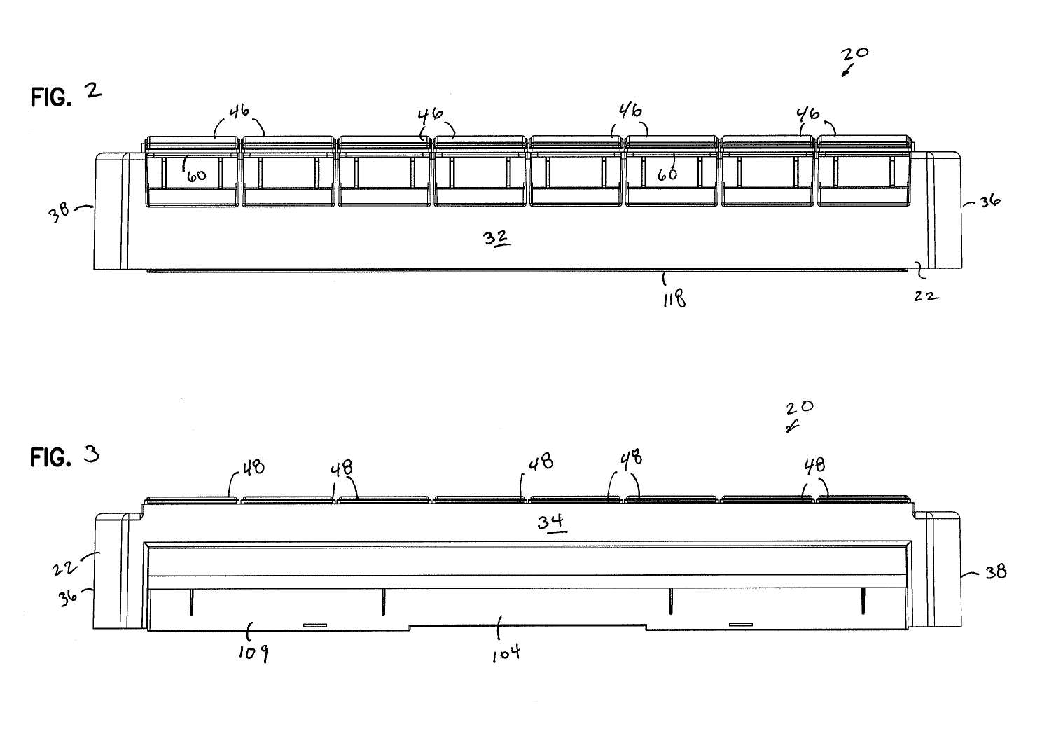

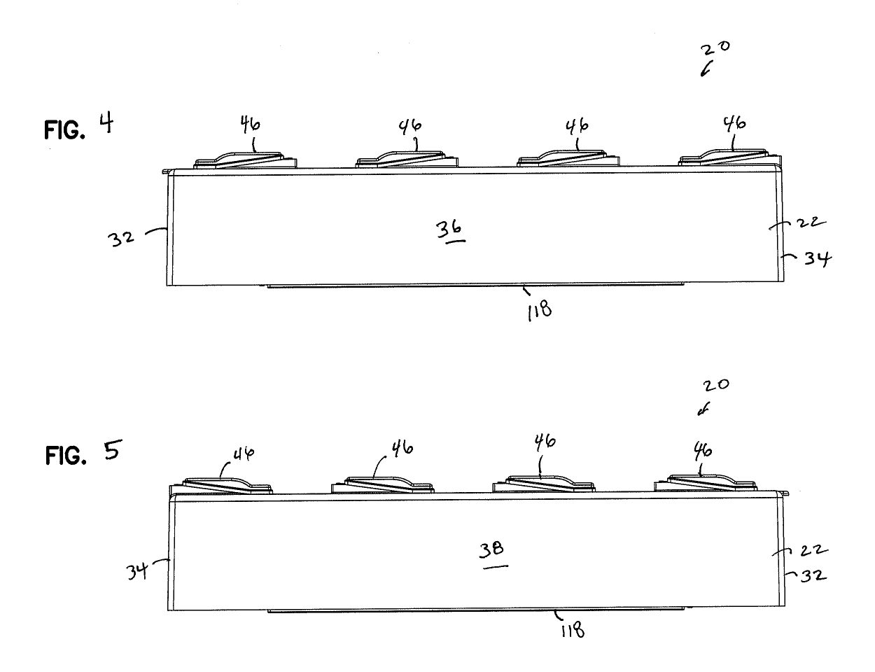

FIG. 1 illustrates a perspective view of one embodiment of a multiple compartment container constructed in accordance with principles of this disclosure generally at 20.

In general, in certain preferred embodiments, the container 20 results in a system that is easy for a person to use, and is improved over other containers. It has been found to be particularly helpful for users on medication in helping them plan their medication. For example, in preferred embodiments, various helpful features include the container 20 having one compartment for each day of the month. Many of the compartments (preferably all of the compartments) are openable by use of a push button. The compartments are organized in rows, and in preferred embodiments, all of the compartments open from the front of the unit. On the underside of the main base, there is a self-contained pill register that is removable. There is a cover on the pill register that is made of a transparent material and is connected by way of a hinge. Not all of these features, or even most of these features, need be part of the container to gain benefits and advantages over the prior art.

In general, the container 20 is useable to hold or store items, such as pills. While pills will be the example discussed, it should be understood that pills can mean vitamins, or it can also mean non-medicinal items. The pills, or whatever items are used, are stored within the container 20 and can be selectively accessed for later use.

In the embodiment shown in FIG. 1, the multiple compartment container 20 includes a base 22. The base 22 has at least first and second rows 24, 25 of compartments 30. In the example shown, the base 22 includes, in addition to the first and second rows 24, 25, third and fourth rows 26, 27 of compartments 30. While many different embodiments are possible, in the one shown, each of the four rows 24-27 includes eight compartments 30 in each row. In other embodiments, there can be fewer rows, and more compartments in each row; while in other embodiments, there can be more than four rows and fewer compartments in each row. Still in other embodiments, there can be more rows that four rows and more compartments than eight compartments in each row.

The compartments 24 are separated from each other by a plurality of dividers 28 (see FIG. 7) within the base 22. The compartments 24 each has an access opening 31 providing access to a pill-holder interior volume 29.

The base 22, in the embodiment shown, has a base front wall 32, a base rear wall 34 opposite of the base front wall 32, a first side wall 36 extending between the base front wall 32 and base rear wall 34, and a second side wall 38 extending between the base front wall 32 and base rear wall 34. A base bottom wall 40 (FIGS. 7-12) is opposite of the access openings 31 of each of the compartments 30. The base bottom wall 40 extends between the base front wall 32 and base rear wall 34 and also between the first side wall 36 and the second side wall 38.

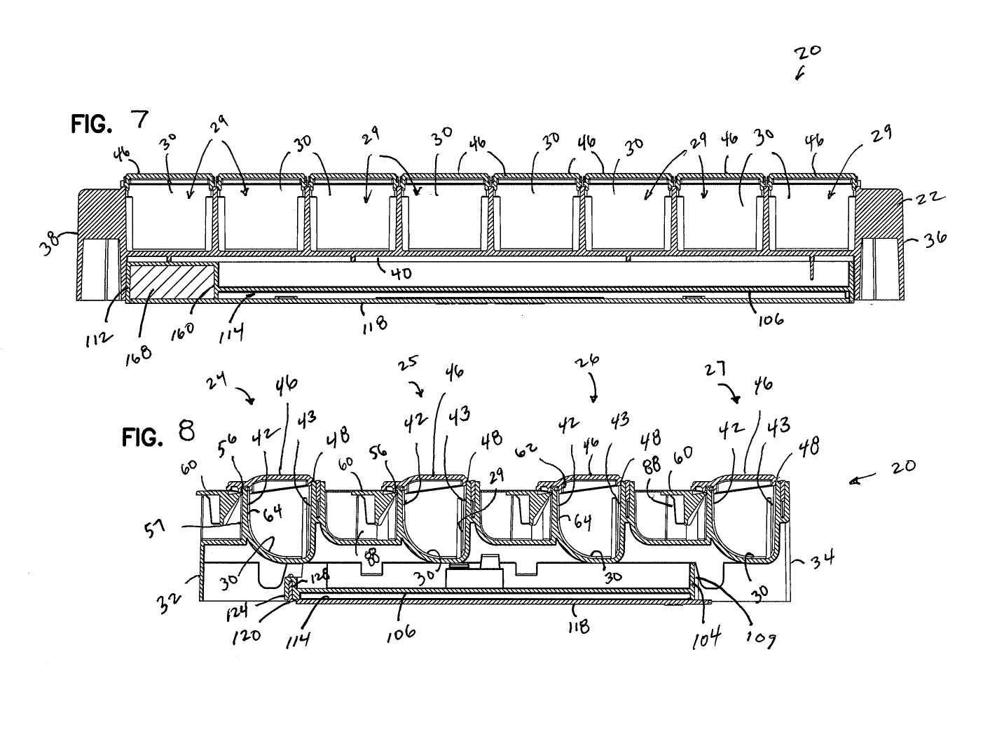

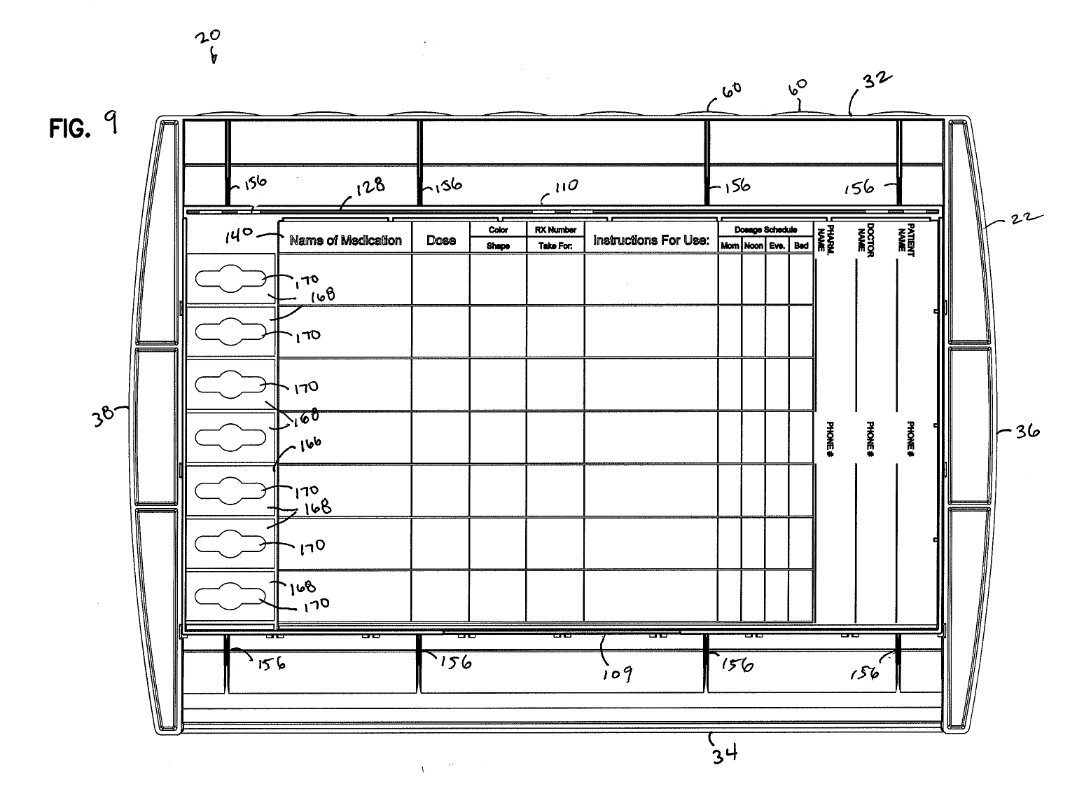

Each of the compartment rows 24-27 has a front row wall 42 and a rear row wall 43 (See FIG. 8). As can be seen in FIG. 8, the rear row wall 43 of each of the rows 24-27 is spaced from the next adjacent front row wall 42 by an open volume to accommodate a push button tab 60, discussed further below.

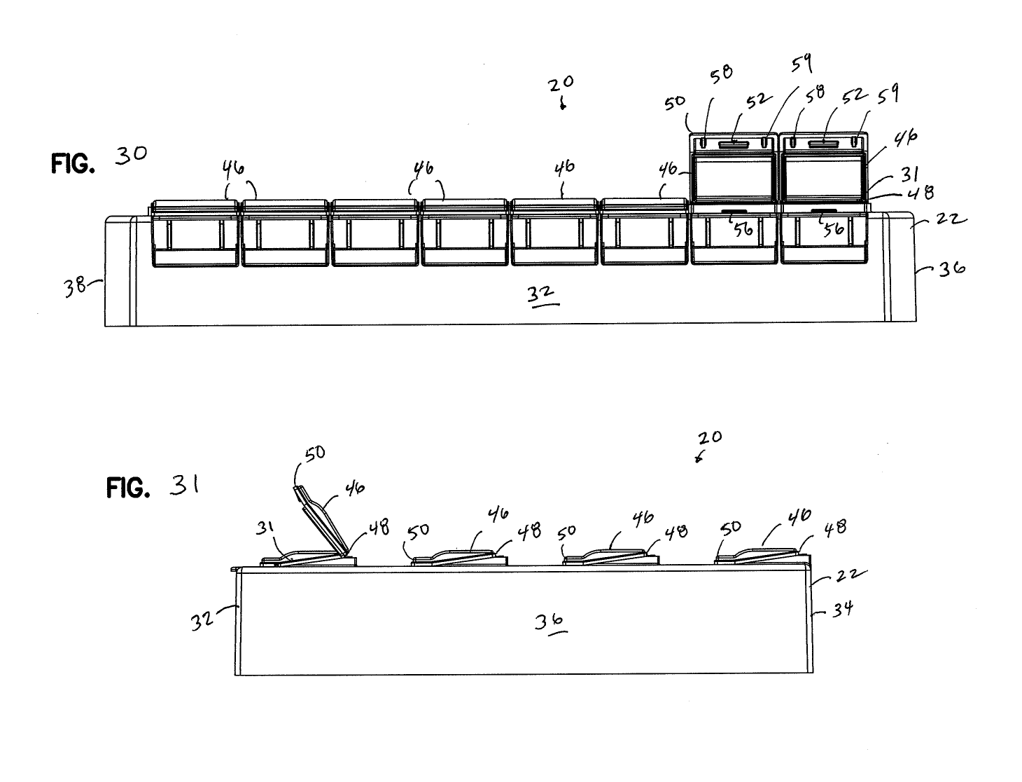

The container 20 includes a plurality of lids 46. Each lid 46 is moveable between a covering position (FIG. 1) and an open position (FIGS. 29-31). The covering position is a position in which a respective one of the lids 46 covers the access opening 31 of a respective one of the compartments 30. In this way, access to the pill holder interior volume 29 is also blocked. The open position is a position in which a respective one of the lids 46 is spaced away from a respective one of the compartments 30 and away from the access opening 31 to allow access to the interior volume 29.

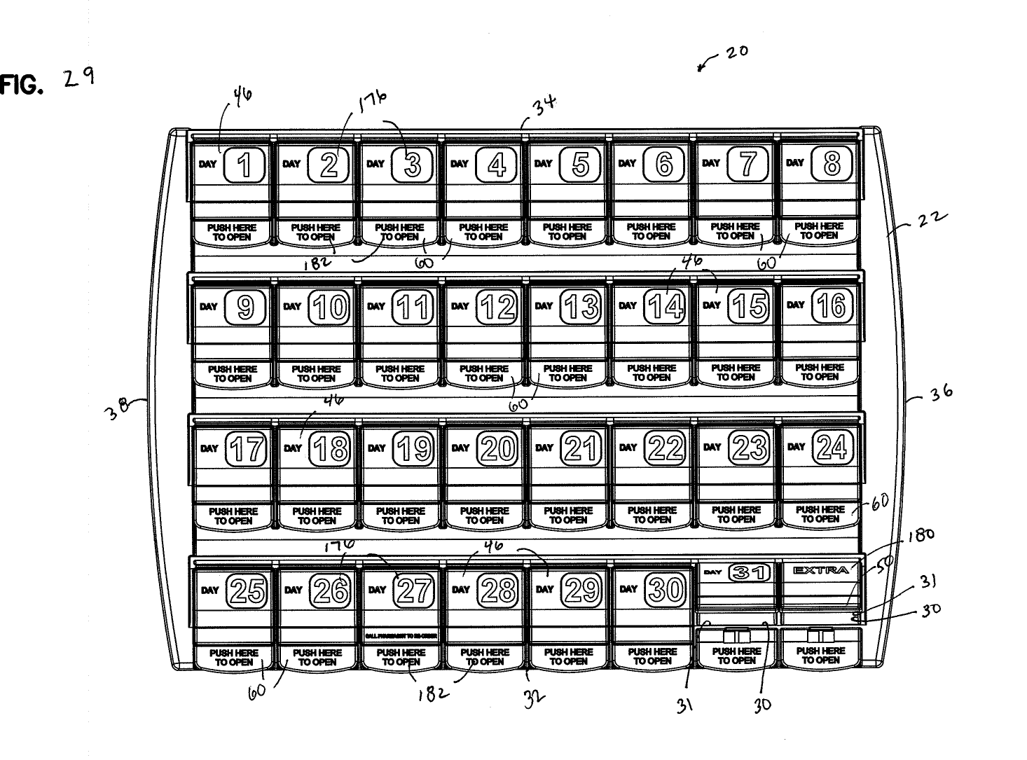

Each lid 46 has an attached end 48 (FIG. 8) movably attached to the rear row wall 43 of its respective row 24-27. This moveable attachment can be through a variety of means, such as by a living hinge. Each lid 46 includes a free end 50 (FIGS. 27-28) that is movable to and away from the front row wall 42 such that the lid 46 selectively covers and uncovers the access opening 31 of a respective compartment 30.

Each of the lids 46 can be selectively snapped into a closed engagement with the base 22. Many different implementations are possible. In this embodiment, the free end 50 has a locking arm 52 (FIGS. 27-28) extending from an inside surface of the lids 46 and toward a direction of the compartment interior volume 29. The locking arm 52 includes a lid catch 56 (FIG. 28), which engages in a snap fit with a base catch 52 (FIG. 8) extending from an outside surface 57 of each of the front row walls 42.

In this embodiment, the free end 50 of each lid 46 can also include first and second standoffs 58, 59 (FIG. 27). The locking arm 52 is centered between the first and second standoffs 58, 59. The standoffs 58, 59 are configured to extend downwardly from the lid 46 and rest on a respective tab 60. The tabs 60 are described further below.

Each of the lids 46 includes a lip member 62. The lip member 62 engages an inside surface 64 (FIG. 8) of the front row wall 42 of the base 22. In this example, the engagement of the lip member 62 and the inside surface 64 of the front row wall 42 contact each other and substantially seals the free end 50 of the lid 46 with the front row wall 42 of the base 22.

As mentioned above, the container 20 includes at least one tab 60. In the embodiment depicted, there is a plurality of tabs 60. In the example embodiment shown, there is one tab 60 for each compartment 30. In other embodiments, there can be different types of arrangements for opening and closing the compartments 30, so each compartment 30 would not necessarily need a tab 60.

In the example shown, each of the tabs 60 is pivotably connected to the base 22 at a location opposite the front row wall 42 from the interior volume 29. Each tab 60 is constructed and arranged such that depressing the tab 60 causes a respective lid 46 to disengage from the snap connection with the front row wall 42 of the base 22 and thereby position the lid 46 to uncover the access opening 31.

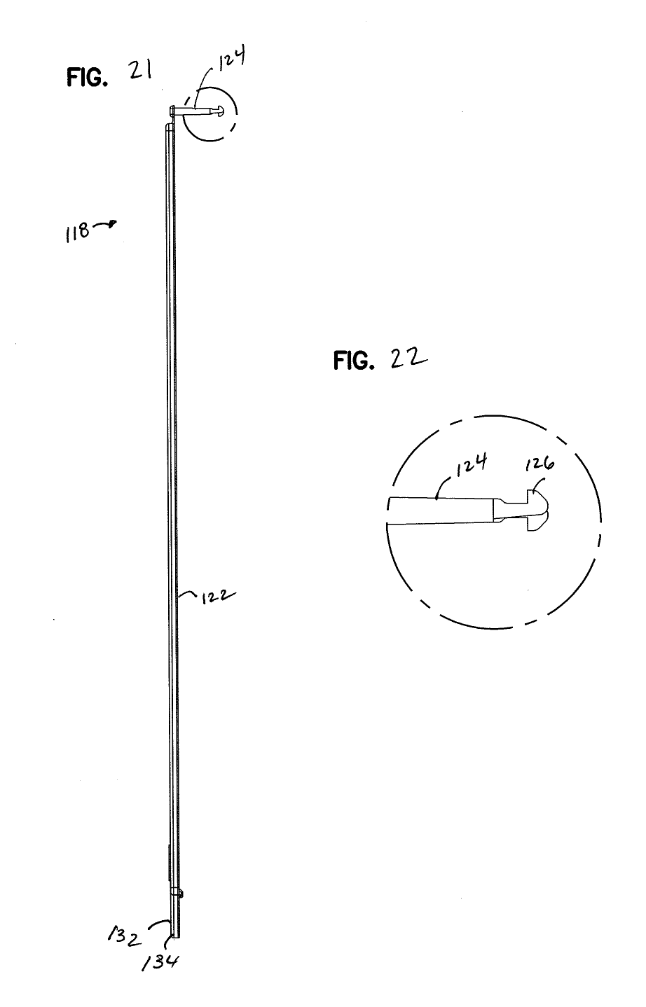

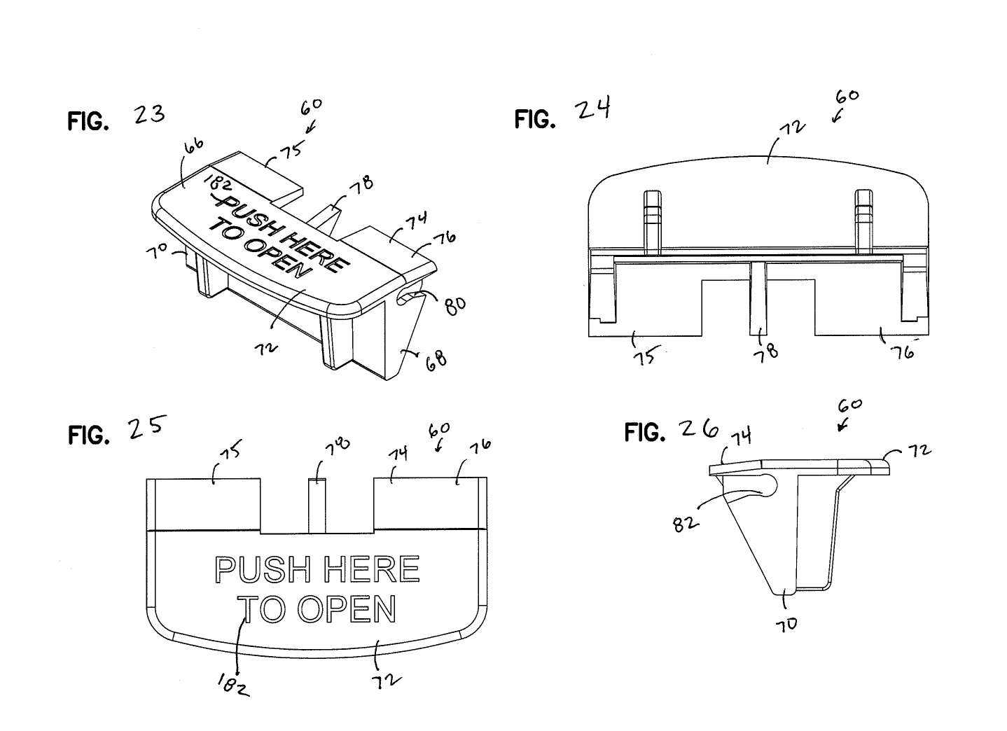

FIGS. 23-26 illustrate tab 60 in greater detail. In the depicted embodiment, the tab 60 includes the top surface 66, a first end portion 68, and a second end portion 70. The top surface 66 includes a front portion 72 and a back portion 74. The back portion 74 is configured to pivot upwards when the front portion 72 is moved downwards. The back portion 74 is configured to raise the free end 50 of the lid 46 and release the locking arm 52 from the base catch 56 when the front portion 72 is depressed.

In the example embodiment depicted, the back portion 74 includes first and second side back members 75, 76 separated by a center back member 78. The center back member 78 is configured to contact the locking arm 52 and move the locking arm 52 from the engaged position (in which the lid catch 54 is engaged with the base catch 56) to a disengaged position (in which the lid catch 54 and base catch 56 are nonengaged). The first side back member 75 and second side back member 76 are configured to contact the first and second standoffs 58, 59 and move them upwards when the front portion 72 of the tab 60 is depressed. This engagement between the side back members 75, 76 and the standoffs 58, 59 further assist with disengaging the lid catch 54 from the base catch 56.

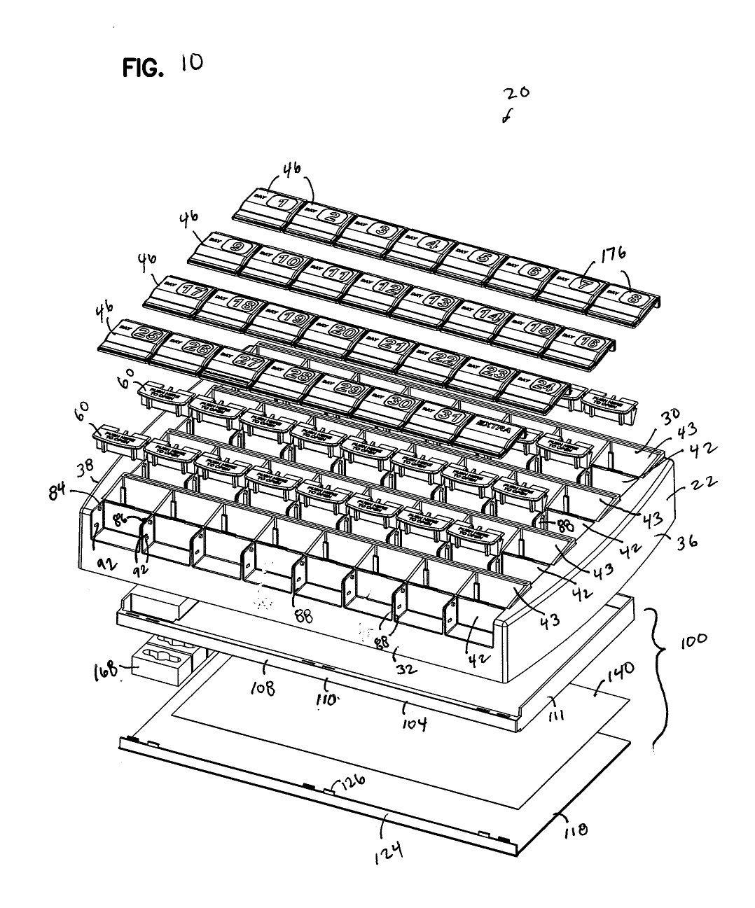

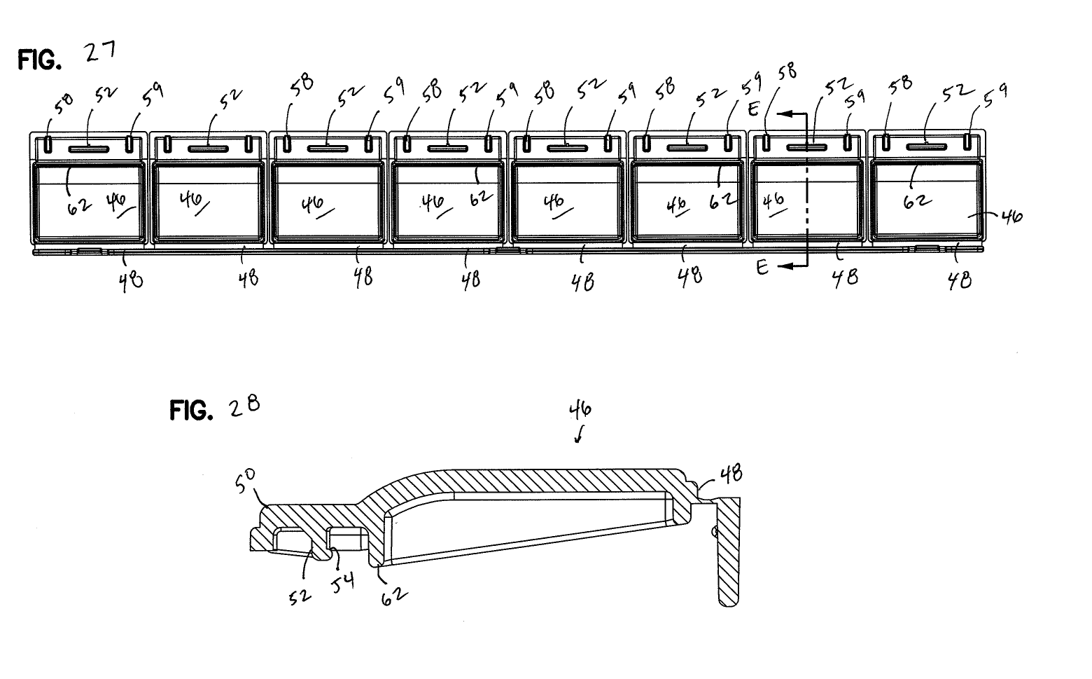

In reference now to FIGS. 23 and 26, in the depicted embodiment, the first end portion 68 (FIG. 23) and the second end portion 70 (FIG. 26) each includes a recess 80, 82. Each recess 80, 82 is configured to engage a pivot protrusion 84, 86 (FIG. 10) on a front end portion 88 of the base 22. The front end portion 88 is the part of the base 22 that is closest to the free end 50 of the lids 46, and is between each respective rear row wall 43 and front row wall 42. The front end portion 88 is on a side of the front row wall 42 that is opposite from the interior volume 29. The recesses 80, 82 are configured to slide into and snap into engagement with the pivot protrusions 86, 84.

The front end portion 88 includes protrusions 92 (FIG. 10) extending therefrom. The protrusions 92 act as rotational stops to limit the rotation of the tab 60 when the lid 46 is locked in place with the base 22. When the lid 46 is disengaged from the base 22, engagement between the center back member 78 and base catch 56 prevent over-rotation.

One example of a push tab assembly, which can be utilized in this embodiment, is described in U.S. Pat. No. 7,624,890, incorporated by reference in its entirety.

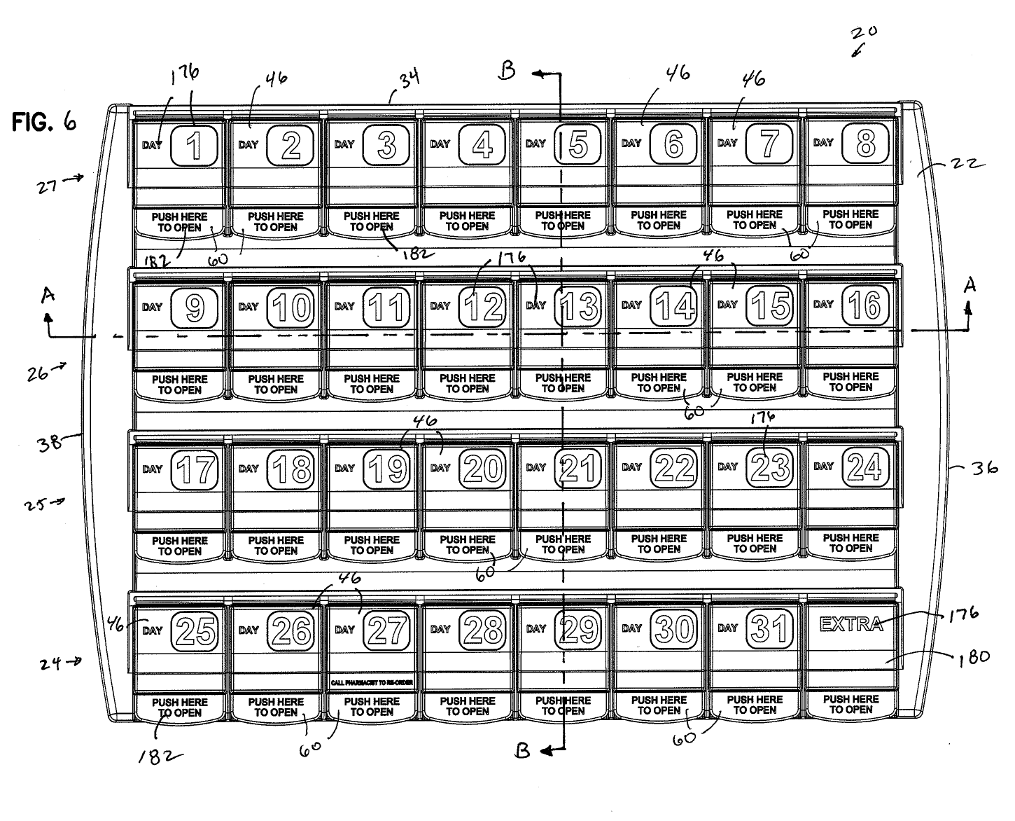

As can be appreciated by reviewing FIGS. 1 and 6, the front row wall 42 of each of the rows 24-27 is nearer to the base front wall 32 than the rear row wall 43 of each of the rows 24-27. In this manner, each respective lid 46 selectively covers and uncovers its respective access opening 31 from the base front wall 32. That is, all of the lids 46 open in the same direction, so that the opening to access the access opening 31 is from the direction of the base front wall 32. This contributes to easier operation of the container 20 than previous prior art containers.

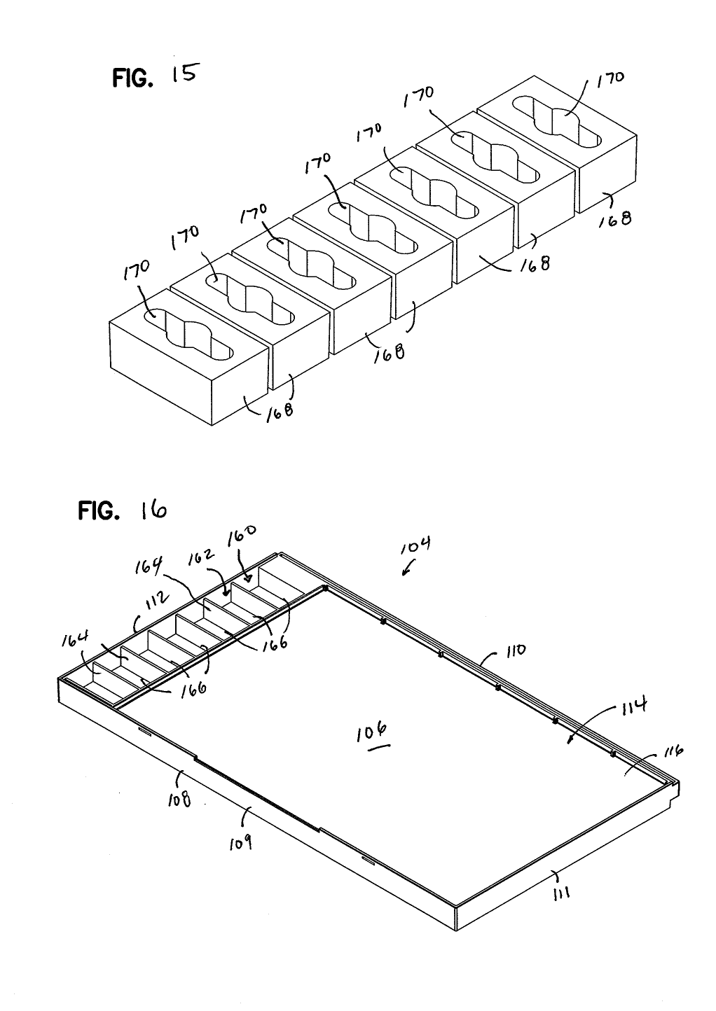

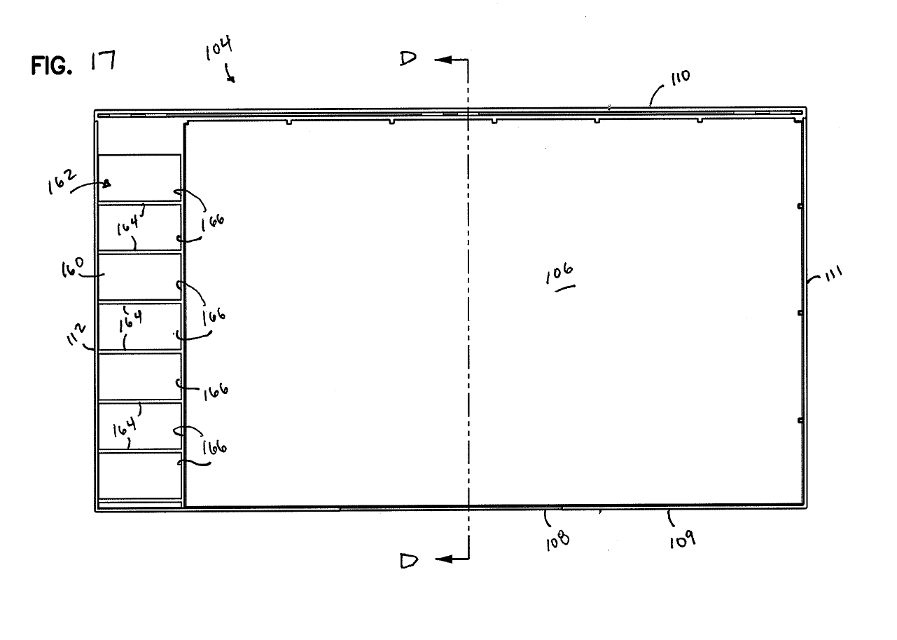

In accordance with principles of this disclosure, the multiple compartment container 20 includes a self-contained register unit 100. The register unit 100 is removably attachable to the base bottom wall 40. The self-contained register unit 100 is depicted in FIGS. 16-19. FIG. 16 is a perspective view of the register unit, which would be visible from the bottom of the container 20. FIG. 18 is a plan view of an opposite side of the register unit 100. The view in FIG. 18 shows the side of the register unit 100 that would be against the base bottom wall 40, and not visible to the user when the register unit 100 is removably attached to the base 22.

The register unit 100, in this embodiment, includes a register base 104. The register base 104 includes a mounting wall 106 and a side wall 108 surrounding the mounting wall 106. In FIGS. 16-19, the side wall 108 includes register front wall 109, register rear wall 110, and register first and second side walls 111, 112 extending therebetween.

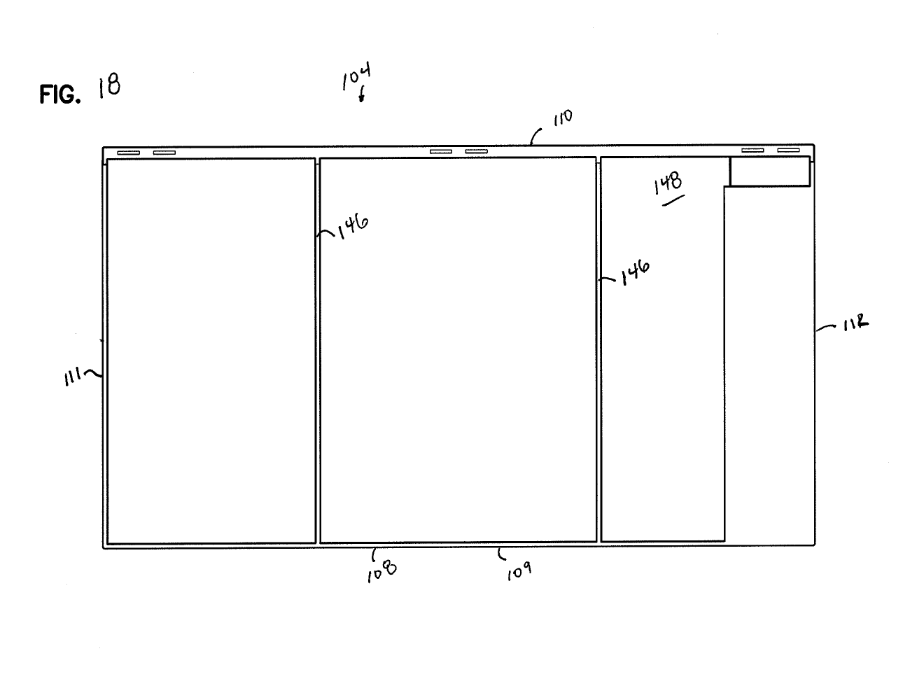

The surrounding wall 108, including, in this embodiment, register walls 109-112, surrounds the mounting wall 106. In the embodiment shown in FIG. 19, the mounting wall 106 is spaced between remote ends of the surrounding wall 108. A register unit volume 114 (FIGS. 7 and 8) is defined by the volume between the mounting wall 106 and the surrounding wall 108 on the side 116 that faces away from the base 22 and is visible to the user when the register unit 100 is removably attached to the base 22. Note that when the register unit 100 is attached to the base 22, the front wall 109 of the register base 104 is adjacent to the container base rear wall 34, while the rear wall 110 of the register base 104 is adjacent to the container base front wall 32. See FIG. 9.

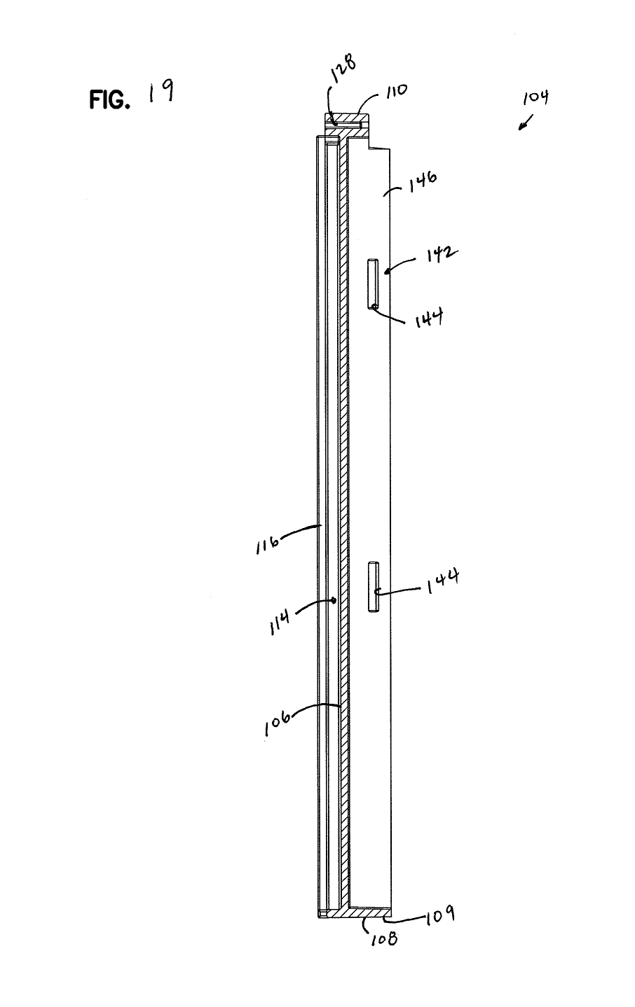

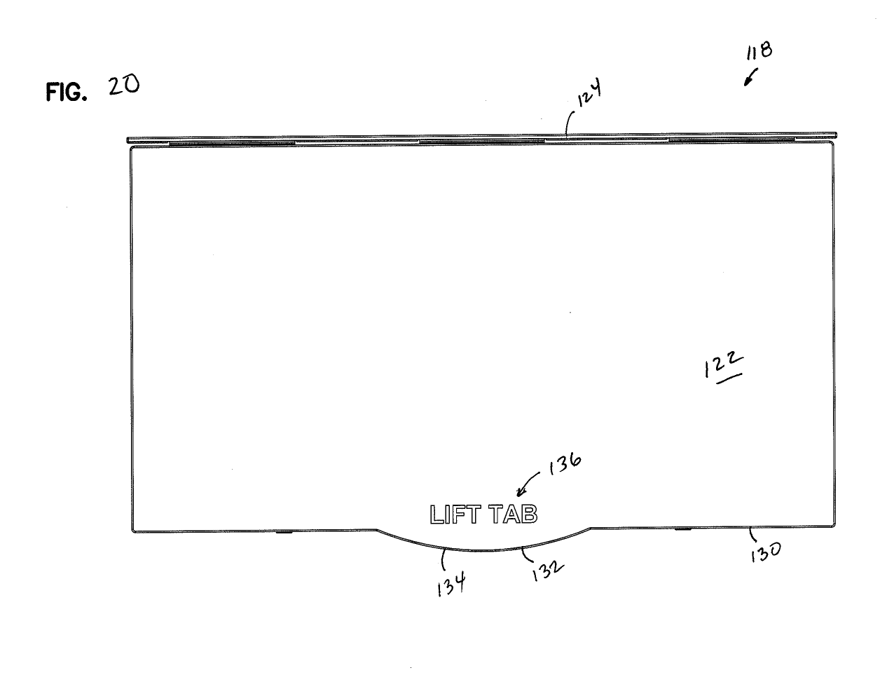

The register unit 100 includes a cover 118 (FIGS. 7, 8, 10, 11, and 20-22). The cover 118 is oriented over the register unit volume 114. In this embodiment, the cover 118 is removably oriented over the register unit volume 114. The cover 118 can be removably attached to the register base 104, and it can be removably attached by way of the hinge connection 120 (FIG. 8). As can be seen in FIGS. 20-22, the cover 118 has a main cover member 122, which in this embodiment is flat, and a projecting flange 124 (FIGS. 21 and 22). The flange 124 is generally perpendicular relative to the main cover member 122. It includes a snap member 126, which is received by the register base 104. See FIG. 8. The register base 104 includes a receiving slot 128 (FIGS. 8 and 19), which receives the snap member 126 therein. The cover 118 is then rotatable about the hinge connection 120 to and from the register base 104.

The cover 118 includes, at an end 130 opposite of the end with flange 124 a handle 132. The handle 132 is the form of a radius curved projection 134 extending from the remaining portion of the cover 118. Adjacent to the handle 132 is indicia 136, indicating that the projection 134 is lift tab. In this manner, the user can grasp the handle 132 at the projection 134 and pivot the cover 118 about the hinge connection 120 away from the register base 104. This will provide access to the register interior volume 114.

Preferably, the cover 118 is made from a transparent material, so that the contents of the register interior volume 114 can be viewed.

A removable card 140 can be removably placed within the register unit volume 114. The card 140 can include information related to what is stored in the compartments 30 of the container 20. For example, when the compartments 30 contain pills, such as medication or vitamins, the information on the card 140 can be related to instructions for use of those pills. In the example shown in FIG. 9, the card 140 includes fields of information related to name of medication, dose, color, shape, prescription number, conditions to take the medication, instructions for use, dosage schedule including time of day, patient name and phone number, doctor name and phone number, and pharmacy name and phone number. Of course, other fields of information could be provided. The card 140 can be paper or cardboard, and it can be replaced with a new card, in case of changes. Alternatively, the card 140 can have instructions written in pencil, so that the information written in the fields can be erased and changed. The card 140 will be removable from the register unit 100 by lifting the cover 118 in order to access the card 140 within the register unit volume 114. It should be noted that the cross-section in FIGS. 7 and 8 do not show the card 140 within the register unit volume 114, for purposes of clarity.

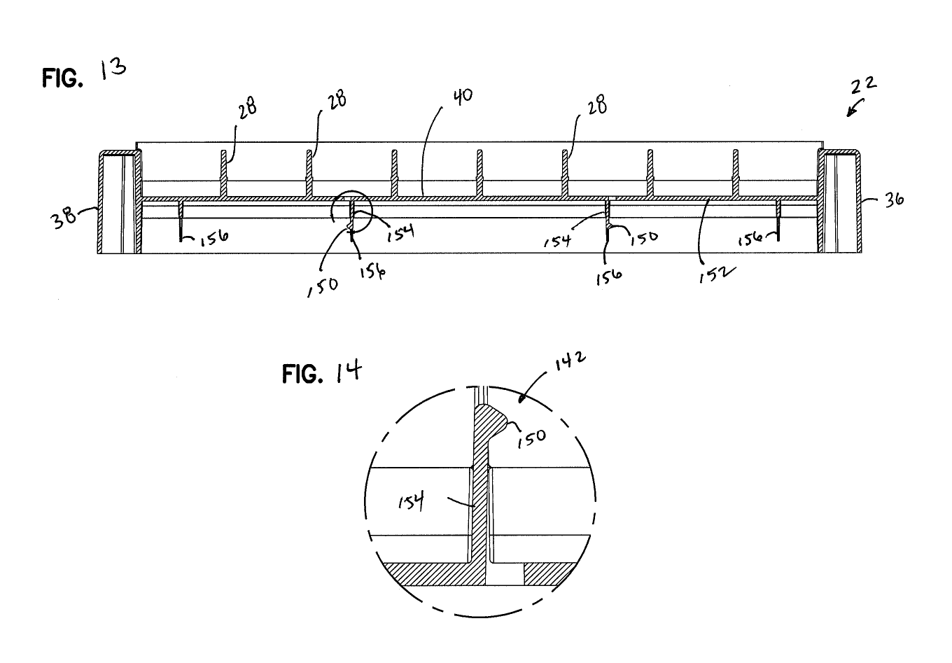

The register unit 100 is removably attached to the bottom wall 40 of the base 22. Many different ways of doing this are possible. In the example shown, and in reference now to FIGS. 12-14 and 19, the base bottom wall 40 and the mounting wall 106 of the register base 104 include a clip and slot arrangement 142. It should be noted that the arrangement 142 is shown both in FIG. 14 and FIG. 19. The clip and slot arrangement 142 can include one of the base bottom wall 40 and mounting wall 106 as including a slot, with the other including a clip. The illustrated embodiment is just one example, and in the embodiment illustrated, the mounting wall 106 includes slots 144 defined by a cross piece 146 extending between the register front wall 109 and register rear wall 110. The cross pieces 146 on the side 148 that is opposite of the side 116. The side 148 is against the base bottom wall 40, and it is not visible to the user when the register unit 100 is attached to the base 22.

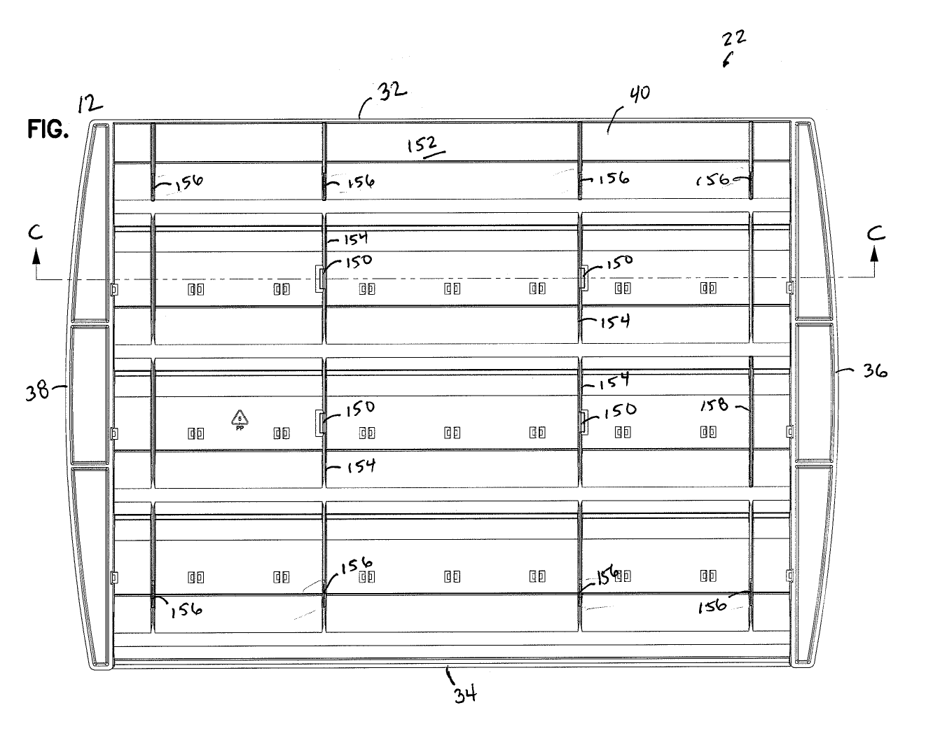

The base bottom wall 40 includes a clip 150 extending from an exterior side 152 (FIG. 13) of the base bottom wall 40. As can be seen in FIGS. 12-14, the exterior side 152 of the base bottom wall 40 includes members 154 projecting from the exterior side 152 of the base bottom wall 40. The members 154 include the clip 150 at a remote end thereof. When the side 148 of the register base 104 is placed against the exterior side 152 of the base 22, the clips 150 will snap in and engage the slots 144 to removably connect the register unit 100, through the snap connection between the register base 104 to the base 22. The register unit 100 can be removed from the base 22 by unsnapping and disengaging the clip and slot arrangement 142.

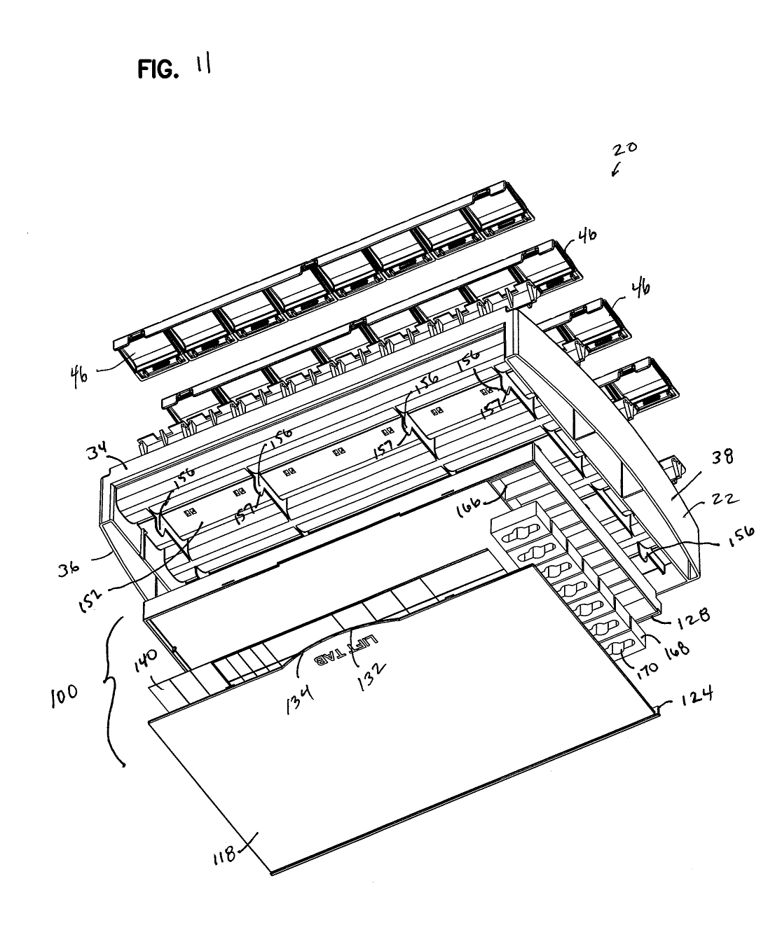

The container base 22 includes, in preferred embodiments, a system to guide the register unit 100 in the correct orientation relative to the container base 22. In the example embodiment shown, the container base includes locator bars 156 (FIGS. 9, 11, and 12) projecting in extension away from the exterior side 152 of the container base 22. The locator bars 156 each have a head 157 (FIG. 11) that helps to hold the register unit 100 in its proper location on the container base 22. As can be seen in FIG.

9, when the register base 104 is oriented within the container base 22, the register base 104 fits between and is held between the bars 156.

In reference now to FIGS. 7 and 16, in this embodiment, the mounting wall 106 of the register base 104 includes a recessed portion 160. The recessed section 160, in this embodiment, is adjacent and against the register second side wall 112. In other embodiments, the recessed portion 160 can be at other locations within the register base 104. The recessed portion 160 provides a storage volume 162 therein. The storage volume 162 is accessible to the user by moving the cover 118 away from the register base 104 to expose the storage volume 162.

In this embodiment, the storage volume 162 includes a plurality of partitions 164 dividing the storage volume 162 into a plurality of individual compartments 166. The compartments 166 can be used to store anything, and in the example shown, each of the compartments 166 includes a pill holder 168 (FIG. 15).

The pill holders 168 can be made from a flexible, open cell foam material, with each pill holder 168 including a storage opening 170 therein. In this manner, each pill holder 168 can be put into one of the compartments 166. An extra pill can be put into the storage opening 170 of each pill holder 168. The pill holders 168 will help to hold extra pills in place in the register base and against gravity, such that the extra pills will not simply fall out of the compartments 166 and be against the cover 118. Of course, the compartments 166 can be used for many other purposes, and this is just one example.

An orientation bar 158 (FIG. 12) can also be provided, in example embodiments, to project away from the exterior side 152 in a manner to cause interference with the register base 104 if the user tries to assemble the register base 104 with the storage volume 162 of the register base 104 on the wrong side of the container base 22. That is, the orientation bar 158 would interfere with the recessed portion 160 of the mounting wall 106, preventing the user from improperly orienting the register base 104 relative to the container base 22.

The container 20 includes written indicia 176 on each of the lids 46. The indicia 176 can say anything for the purposes of the container 20. In the embodiment depicted, the indicia 176 include the day of each month, so that the container 20 can include daily medication organized by day and on a monthly basis. On each of the lids 46 there can also be braille to assist the visually impaired. In the example shown in the FIGS., there are thirty-two compartments 30, so after accounting for each of the days of a 31 day month, there is at least one extra compartment 180. The extra compartment 180 can include extra pills. During months that have fewer than 31 days, there will be 2 or 3 extra compartments 30. In FIG. 1, the indicia 176 for the extra compartment 180 are labeled as “extra.” Of course, many variations in the indicia 176 are possible.

Each of the tabs 60 includes the word “push here to open” at 182 to provide instructions on how to operate the container 20 in order to provide access to the interior volume 29. The instruction at 182 provides the user with information that to move the lid 46 from the locked and closed position to the open position uncovering the access opening 31, the tab 60 should be pushed. Of course, other variations on the instruction 182 are possible.

In use, the multiple compartment container 20 can be used to help store and manage pills, such as medications or vitamins. In the method, the base 22 is provided. The base 22 will include compartments 30 and lids 46. The self-contained register unit 100 is provided. The self-contained register unit 100 can then be removably attached to the bottom wall 40 of the base 22.

The method can include placing removable card 40 with information in the register unit 100. The information can include, for example, instructions for use of the contents of the compartments 30. For example, this can include dosage information and scheduling, among other items of information. The card 140 can be placed in the register unit by lifting the cover 118 using the handle 132, and then placing the card 140 in the register unit volume 114.

The step of removably attaching the self-contained register unit 100 to the bottom wall 40 of the base 22 can include removably connecting the base bottom wall 40 and the mounting wall 106 of the register base 104 by engaging a clip and slot arrangement 142.

The step of removably attaching the self-contained register unit 100 to the bottom wall 40 of the base 22 can include orienting the register base 104 within locator bars 156 extending from the exterior side 152 of the base bottom wall 40.

The method can also include accessing at least one of the compartments 30 in the container 20 by depressing the front portion 72 of one of the tabs 60 to cause the back portion 74 of the tab 60 to contact a respective lid 46 and disengage the free end 50 of the lid 46 from the front row wall 42 and thereby position the lid 46 to uncover the access opening 31.

The above represents example principles of this disclosure. Many embodiments can be made using these principles.

What is claimed is:

1. A multiple compartment container comprising:
(a) a base having at least first and second rows of compartments, each compartment having an access opening providing access to an interior volume;
(i) the base having a base front wall, a base rear wall opposite of the base front wall, a first side wall extending between the base front wall and base rear wall, a second side wall extending between the base front wall and rear wall, and a base bottom wall opposite of the access opening;
(ii) each compartment row having a front row wall and a rear row wall;
(b) a plurality of lids;
(i) each lid having an attached end being movably attached to the rear row wall, and a free end movable to and away from the front row wall such that the lid selectively covers and uncovers the access opening of a respective compartment; and
(c) a self-contained register unit removably attached to the bottom wall of the base.

2. A container according to claim 1 wherein:
(a) the register unit includes a register base having a mounting wall, a sidewall surrounding the mounting wall to define register unit volume therein, and a cover oriented over the register unit volume.

3. A container according to claim 2 further comprising:
(a) a removable card with information oriented in the register unit volume.

4. A container according to claim 2 wherein:
(a) the cover is removably attached to the register base.

5. A container according to claim 4 wherein:
(a) the cover is hingedly attached to the register base.

6. A container according to claim 2 wherein:
(a) the bottom wall of the base and the mounting wall of the register base include a clip and slot arrangement to removably connect the register base and container base together.

7. A container according to claim 2 wherein:
(a) the mounting wall includes a recessed portion to provide a storage volume therein; the storage volume being accessible by moving the cover to expose the storage volume.

8. A container according to claim 7 wherein:
(a) the storage volume includes a flexible pill holder to hold a pill therein against gravity.

9. A container according to claim 1 wherein:
(a) the front row wall of each of the at least first and second rows is nearer to the base front wall than the rear row wall of each of the at least first and second rows so that each respective lid selectively covers and uncovers the respective access opening from the base front wall.

10. A container according to claim 9 wherein:
(a) the at least first and second rows of compartments include four rows of compartments.

11. A container according to claim 9 wherein:
(a) each of the four rows of compartments includes 8 compartments in each TOW.

12. A container according to claim 1 wherein:
(a) each lid includes a lid catch at the free end releasably engaging a base catch on the front row wall.

13. A container according to claim 12 further comprising:
(a) a plurality of tabs pivotably connected to the base at a location opposite the front row wall from the interior volume, wherein each tab is constructed and arranged such that depressing a front portion of the tab causes a rear portion of the tab to contact a respective lid and disengage the free end of the lid from the front row wall and thereby position the lid to uncover the access opening.

14. A method of using a multiple compartment container, the method comprising:
(a) providing a container including a base having at least first and second rows of compartments, each compartment having an access opening providing access to an interior volume;
(i) the base having a base front wall, a base rear wall opposite of the base front wall, a first side wall extending between the base front wall and base rear wall, a second side wall extending between the base front wall and rear wall, and a base bottom wall opposite of the access opening; each compartment row having a front row wall and a rear row wall;
(ii) the container having a plurality of lids; each lid having an attached end being movably attached to the rear row wall, and a free end movable to and away from the front row wall such that the lid selectively covers and uncovers the access opening of a respective compartment;
(b) providing a self-contained register unit; and
(c) removably attaching the self-contained register unit to the bottom wall of the base.

15. A method according to claim 14 further comprising:
(a) placing a removable card with information in the register unit.

16. A method according to claim 14 wherein:
(a) the register unit includes a register base having a mounting wall, a sidewall surrounding the mounting wall to define register unit volume therein, and a cover oriented over the register unit volume; and
(b) the step of removably attaching includes removably connecting the bottom wall of the base and the mounting wall of the register base by engaging a clip and slot arrangement.

17. A method according to claim 16 further comprising:
(a) moving the cover relative to the register base; and
(b) orienting a removable card with information in the register unit volume.

18. A method according to claim 17 wherein:
(a) the step of moving the cover includes pivoting the cover relative to the register base.

19. A method according to claim 14 wherein:
(a) the front row wall of each of the at least first and second rows is nearer to the base front wall than the rear row wall of each of the at least first and second rows so that each respective lid selectively covers and uncovers the respective access opening from the base front wall;
(b) each lid includes a lid catch at the free end releasably engaging a base catch on the front row wall;
(c) the container includes a plurality of tabs pivotably connected to the base at a location opposite the front row wall from the interior volume; and
(d) the method further comprises depressing a front portion of one of the tabs to cause a back portion of the tab to contact a respective lid and disengage the free end of the respective lid from the front row wall and thereby position the respective lid to uncover the access opening.
